(19) United States
(12) Patent Application Publication
(10) Pub. No.: US 2006/0058940 A1
(43) Pub. Date: Mar. 16, 2006

(54) Traffic information prediction system

(76) Inventors: Masatoshi Kumagai, Hitachi (JP); Takumi Fushiki, Hitachi (JP); Takayoshi Yokota, Hitachiota (JP)

Correspondence Address: CROWELL & MORING LLP;INTELLECTUAL PROPERTY GROUP, P.O. BOX 14300, WASHINGTON, DC, 20044-4300, US

(21) Appl. No.: 11/206,816

(22) Filed: Aug. 19, 2005

(30) Foreign Application Priority Data
Sep. 13, 2004 (JP) 2004-264803

(51) Int. Cl. G06G 7/76

(52) U.S. Cl. 701/117; 340/995.13

(57) ABSTRACT

A traffic information prediction system has a traffic information database for recording time sequential data of traffic information and a traffic condition change factor database for recording the location, time period and type of an event which may change traffic conditions. The time period and location of the change are detected from data distributions of the traffic information, the change being unable to be explained even by day factor information such as days of the week, seasons and commercial calendar, and weather information. An event having a relatively shorter temporal and spatial distance from the detection results is searched from the traffic condition change factor database. The traffic information prediction system can detect an occurrence of an event changing the traffic conditions and its influence area.

### CROSS-REFERENCE TO RELATED APPLICATION

This application relates to an application U.S. application Ser. No. ______ filed on Jul. 27, 2005 based on Japanese Patent Application No. 2004-219491 filed on Jul. 28, 2004 and assigned to the present assignee. The disclosure of that application is incorporated into this application by reference.

### BACKGROUND OF THE INVENTION

1. Field of the Invention

The present invention relates to providing traffic information on which a change in traffic conditions is reflected.

2. Description of the Related Art

A traffic information providing method using day factors, which is one of the mainstreams of conventional statistical traffic information providing methods, can provide numerical traffic information such as travel time, congestion level and traffic volume in such a manner that the day factors such as days of the week, seasons and commercial calendar are reflected on the numerical traffic information (for example, refer to JP-A-2001-118188). In a method using day factor classification, such as the necessary time guidance by the Metropolitan Expressway Public Corporation, traffic information accumulated in the past is classified in accordance with a combination of day factors, and representative values such as average values at same times are calculated for each classification unit to provide them as prediction values of traffic information (for example, refer to “Analysis of Necessary Time Change Characteristics: the Metropolitan Expressway Public Corporation” by Warita, et. al. Reports of Papers, 22nd Traffic Engineering Study Conference, October, 2002, pp. 61-64).

Providing traffic information by statistically processing past traffic information and using day factors is realized on the assumption that the traffic conditions at a subject road during the past period while traffic information was accumulated and a present time can be explained approximately in association with day factors. This assumption is also true for prediction methods such as multiple regression analysis and neural network which input day factors. However, if the accumulated traffic information represents the data having, for example, a travel time changed by an event which changes the traffic conditions, such as road building, opening of a large shop and traffic stop due to disaster, then it is impossible to explain this traffic information in association with only the day factors, and the obtained traffic information takes an intermediate value of the traffic information before and after the event.

If accumulated traffic information is classified in accordance with a temporal and spatial area influenced by an event, it is possible to provide the traffic information reflecting the influence.

Information sources for an occurrence of such events are limited to trouble information of vehicle information communication service (VICS) and the like. The contents of this information are limitative in that (1) only predefined events are used, (2) information is related to only an occurrence location of an event and does not show a clear temporal and spatial influence area of an event upon traffic conditions, and (3) since data input is made mainly manually, the data cannot cover various traffic conditions. Accident information of VICS is acquired by notices from an event occurrence location. Even if an accident is detected by image processing, a detectable area is limited to an area where the camera can take an image. Further, a detectable accident is limited to such an accident having a large scale to some extent. Still further, an event other than an accident cannot be detected and an influence area of the event cannot be specified.

### SUMMARY OF THE INVENTION

The issues to be solved by the present invention reside in that in providing event information which changes the traffic conditions and statistical traffic information obtained by referring to event information, an occurrence of an event and its influence area cannot be detected automatically, and it is not possible to calculate prediction information in accordance with a quantitative identification of change quantities of past traffic information caused by events.

Accumulated past traffic information is divided into a plurality of periods, the data distributions of two periods are compared, if a statistically significant difference is detected between the data distributions of two periods, it is judged that there was a change in traffic information caused by a factor different from day factors such as days of the week, seasons and commercial calendar and weather information, and prediction information is calculated by regression analysis reflecting change quantities as parameters. A traffic event having a shorter spatial and temporal distance from the detection results is retrieved from traffic event candidates stored beforehand in a database, and the detection results of the traffic information change and the prediction information are presented to users so that the users are urged to grasp a change in traffic conditions and its cause to support a proper route selection.

A traffic information providing apparatus according to the present invention detects a change in traffic conditions from data distributions of traffic information, and a traffic event having a high spatial and temporal relation to the detection results is selected as a change cause from the database. Accordingly, even if traffic events registered in the database do not have definite information on a spatial/temporal influence area, an occurrence of a traffic event changing the traffic conditions can be detected from data not directly indicating an occurrence of a traffic event such as a travel time and a congestion degree, and the contents of the traffic event and its influence area can be explained.

Other objects, features and advantages of the invention will become apparent from the following description of the embodiments of the invention taken in conjunction with the accompanying drawings.

### BRIEF DESCRIPTION OF THE DRAWINGS

FIG. 1 shows an example of an information providing screen of a traffic information system.

FIG. 2 shows an example of character information displayed on the information providing screen of the traffic information system.

FIG. 3 is a block diagram of a system for detecting an event which changes traffic conditions.

FIG. 4 is a conceptual diagram illustrating a method of detecting a change in traffic conditions.

FIG. 5 is a conceptual diagram illustrating a method of detecting a change in traffic conditions.

FIG. 6 shows an example of a format of an information database of events which change traffic conditions.

FIG. 7 is a conceptual diagram illustrating a method of estimating an event which changes traffic conditions.

FIG. 8 is a block diagram of a system for calculating change components of traffic conditions.

FIG. 9 shows an example of a format of event occurrence information to be used for calculating change components of traffic conditions.

FIG. 10 is a block diagram of a traffic information prediction system reflecting event information and day factor information causing a change in traffic conditions.

FIG. 11 is a block diagram of a system for detecting an event which changes traffic conditions.

FIG. 12 is a flow chart illustrating a method of displaying a change area of traffic conditions.

FIGS. 13A to 13E are conceptual diagrams illustrating a method of displaying a change area of traffic conditions.

FIG. 14 is a flow chart illustrating a method of detecting a change in traffic conditions.

FIG. 15 is a flow chart illustrating a method of detecting a change in traffic conditions.

FIG. 16 is a conceptual diagram illustrating a method of detecting a change in short term traffic conditions.

### DESCRIPTION OF THE EMBODIMENTS

Description will be made of a traffic information providing apparatus of the present invention for automatically detecting an occurrence of an event which changes traffic conditions and an area influenced by the event.

### FIRST EMBODIMENT

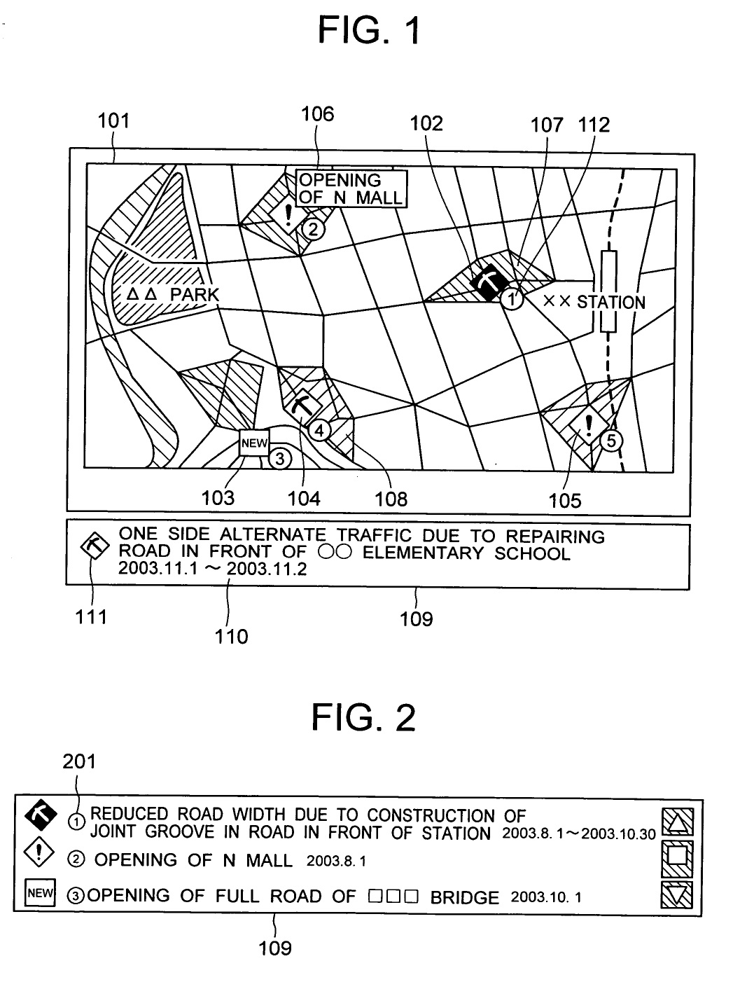

FIG. 1 shows a display screen of a traffic information providing apparatus such as a car navigation apparatus. Traffic information is displayed superposed upon a map displayed in a map display unit 101. Icons 102 to 106 show occurrence locations of events (hereinafter called traffic events) which change traffic conditions, such as construction, road building and repairing, traffic accident, natural disaster, opening of a large scale shop and general events. Predefined traffic events are represented by icons schematically showing the types of traffic events such as icons 102 to 104. Traffic events not predefined or traffic events whose occurrence cause is indefinite are represented by icons drawing general attention such as icon 105 with “!” mark having character information 106 for distinguishment between traffic events. A traffic event which degrades traffic conditions such as construction and a traffic event which improves traffic conditions such as road building are represented by icons having different colors and shapes for user distinguishment, such as icons 102 and 103. Generally distributed information such as information by VICS and information detected by traffic event detecting technologies of the present invention are represented by icons having different colors or shapes for user distinguishment such as icons 102 and 104, even both the information corresponds to the traffic event of the same type. Areas 107 and 108 indicate ranges of traffic conditions influenced by traffic events. Areas having different colors and hatching patterns are used for distinguishing between improvement/degradation of traffic conditions and between short term traffic events causing a change in traffic conditions such as traffic accidents and general events and long term traffic events causing a change in traffic conditions such as road building and opening of a large scale shop.

As the icon representative of the traffic event or the area representative of the traffic event influence range is pointed out on the map display unit 101, the detailed information on the traffic event such as the contents, location and time period of the traffic event corresponding to the selected icon or area is displayed in characters on a character information display unit 109. In this case, an icon 111 corresponding to the icon displayed on the map display unit 101 is displayed along with character information 110 on the traffic event, to visually show a correspondence with the traffic event displayed on the map display unit 101. If the pointed area is influenced by a plurality of traffic events, all the traffic events related to this area are displayed in characters on the character information display unit 109.

In the example shown in FIG. 1, the traffic event of the icon 104 pointed out on the map display unit 101 is displayed on the character information display unit 109. Instead of selecting a single traffic event, as shown in FIG. 2 a list of the detailed information on all traffic events displayed on the map display unit 101 may be displayed in characters on the character information display unit 109. In this case, to distinguish between respective traffic events, serial numbers 201 are allocated to the traffic events to be displayed, and displayed along with the detailed information on the traffic events. The same number 112 is added to the icon on the map display unit 101 corresponding to the serial number 201 to show a correspondent between information on the map display unit and character information display unit.

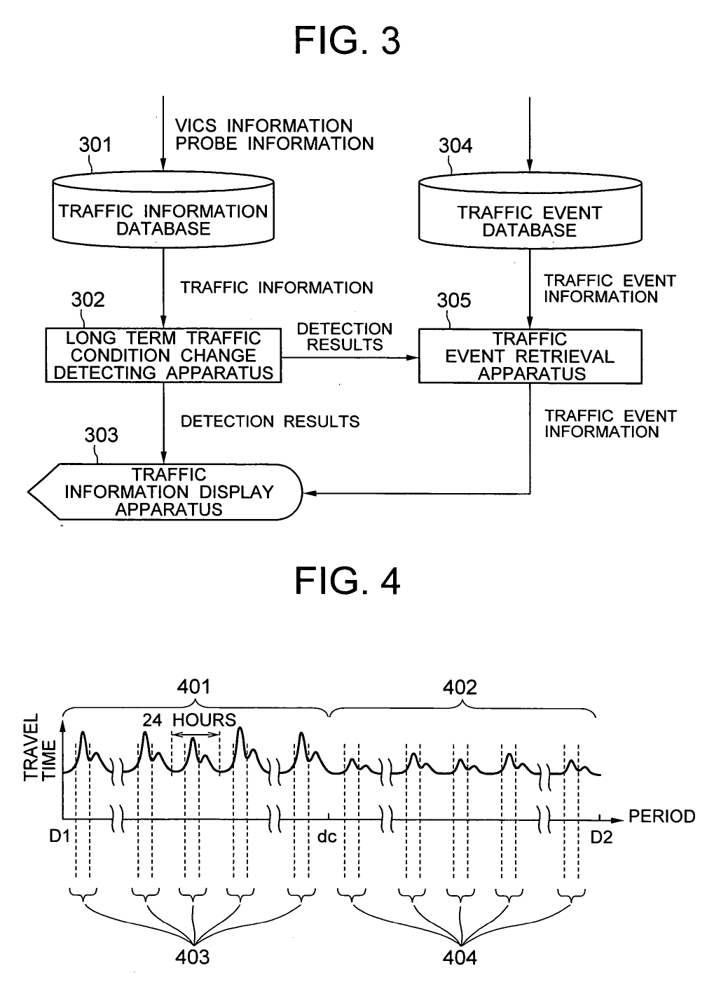

FIG. 3 shows a configuration of a system for detecting an occurrence of a long term traffic event such as road building, opening of a large scale shop, traffic regulations set for a long term disaster and construction, and displaying the information shown in FIG. 1. A traffic information database (hereinafter written as a traffic information DB) 301 accumulates real time traffic information distributed from VICS, a probe car/floating car system or the like. A long term traffic condition change detecting apparatus 302 detects a change in traffic conditions due to an occurrence of a long term traffic event from the traffic information accumulated in the traffic information DB 301. This detection method will be described with reference to the conceptual diagram of FIG. 4.

In FIG. 4, past traffic information was accumulated during a period [D1, D2]. The traffic information data during the period [D1, D2] is divided at an arbitrary time point dc. A distribution of a traffic information data group 401 during a period [D1, dc] is compared with a distribution of a traffic information data group 402 during a period [dc, D2]. If it is statistically judged that the distributions are different, and it is decided that a traffic event occurred before or after the time point dc and changed the traffic conditions. For distribution comparison between the traffic information data groups, comparison using dispersion or χ-square test can be used. Traffic information usable for the comparison includes a travel time, a congestion level, an average vehicle speed, a traffic volume and the like. It is possible to know the time point at which the traffic conditions changed by performing the above-described judgement while changing the time point dc from D1 to D2.

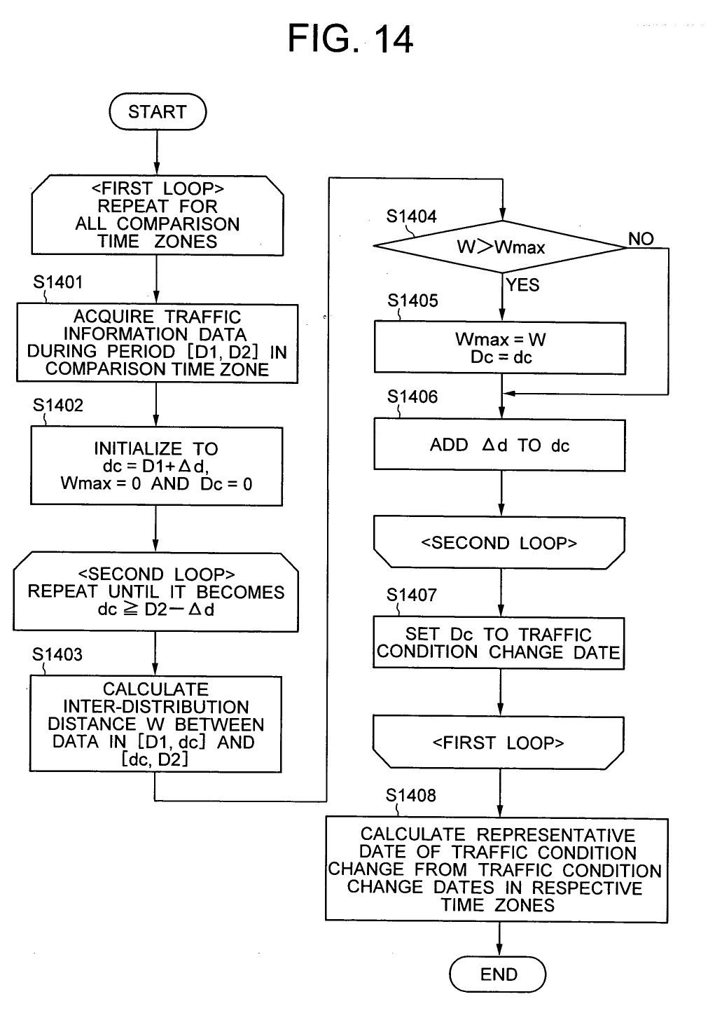

This process is illustrated in the flow chart of FIG. 14. In this example, it is assumed that distribution comparison between the traffic information data group 401 during the period [D1, dc] and the traffic information data group 402 during the period [dc, D2] is performed, for example, between traffic information data groups 403 and 404 for each time zone. It is also assumed that D1, D2 and dc shown in FIG. 4 indicate a date. The comparison is performed for each time zone to detect a change in traffic conditions because even if comparison between the traffic information data groups in a day does not show a large difference, comparison between the traffic information data groups in a short time zone shows a large difference. In the following, the flow chart of FIG. 14 will be described. In the process of a first loop for comparison at each time zone, first at Step 1401 (hereinafter, Step is abbreviated to S), traffic information data of a road link, from which a change in traffic conditions during the period [D1, D2] in the comparison time zone is to be detected, is acquired from the traffic information DB 301. Next, at S1402 shown in FIG. 14, dc is initialized to D1+Δd and Wmax and Dc are initialized to 0, and the process of a second loop is repeated until it becomes dc≧D2−Δd. Inside the second loop, at S1403 the traffic information data is divided into the traffic information data during the period [D1, dc] and the traffic information data during the period [dc, D2], to calculate an inter-distribution distance W between the data groups during the periods. At S1404, Wmax is compared with W. If W is larger than Wmax, at S1405 the value of Wmax is renewed to W and the value of Dc is renewed to dc. At S1406, Δd is added to dc to return to the top of the second loop. After the completion of the second loop, it is possible to obtain the date Dc in which the inter-distribution distance between two data groups becomes maximum and the maximum inter-distribution distance Wmax. At S1407 Dc is used as a traffic condition change date in the present comparison time zone. The process of the first loop from S1401 to S1407 is repeated for all comparison time zones. Thereafter, at S1408 a statistical representative value (average value, median value mode value or the like may be used) is calculated from traffic condition change dates in time zones recorded at S1407. This statistical representative value is used as a representative date in which the traffic conditions changed. For example, the comparison time zone is set in the unit of two hours, e.g., from 06:00 to 20:00 to compare traffic information data in two hours by one cycle of the first loop. If the division unit is coarse, the number of repetition times of the first loop becomes small, whereas if the division unit is fine, a local change can be detected such as a change which occurs only during a period from 07:00 to 08:00 in the morning. The range of the comparison time zone, the division method and the like are not limited to those described above. For example, comparison between traffic information data in the night is not performed because the traffic volume in the night is generally small.

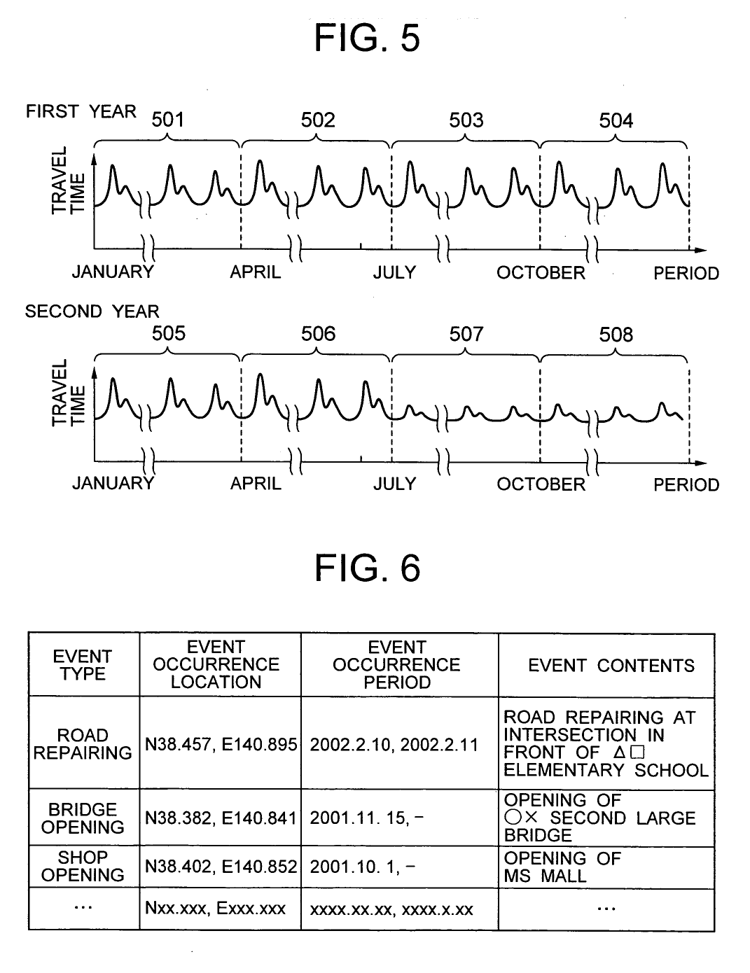

If traffic information contains a season variation, not simply dividing data into two data groups before and after a certain date as shown in the example of FIG. 4, but data is divided into data groups of each season, and distributions of data groups in each season are compared so that a change in traffic conditions can be detected by removing the influence of the season variation. FIG. 5 is a diagram illustrating this concept. In order to compare the data groups, data accumulated for two years is divided into four periods per one year: periods 501 to 508. The periods in the first year are the periods 501 to 504, and the periods in the second year are the periods 505 to 508. The periods in the same season include the periods 501 and 505, the periods 502 and 506, the periods 503 and 507 and the periods 504 and 508. Distributions of the data groups of the first and second years in the same season period are compared. For example, the traffic information data groups in the periods 501 and 505 and the traffic information data groups in the periods 502 and 506 are judged having statistically the same distribution and the traffic data groups in the periods 503 and 507 and in the periods 504 and 508 are judged having statistically different distributions. If a difference between distributions during the periods 502 and 503 is smaller than a difference between distributions during the periods 506 and 507, it can be judged that a change in traffic conditions different from the season variation occurred during the period between the periods 506 and 507, because the season variation is smaller than a change in traffic conditions such as road building.

In the example shown in FIG. 5, the number of divided periods per one year is set to “4” corresponding to the number of seasons, spring, summer, autumn and winter and the accumulation period for traffic information is set to two years. These values may be set arbitrarily in accordance with actual circumstances such as a season variation in traffic information and a temporal trend. For example, if the length of a divided period is set to one week, a change in long term traffic conditions can be detected at a resolution of one week. Alternatively, if traffic information has a temporal trend and traffic information in the second year is offset from the traffic information in the first year, a change in traffic conditions can be detected by using the inter-distribution distance of the traffic information data groups as an evaluation criterion and not by evaluating the similarity of distributions of the traffic information data groups in each season in the first and second years. For example, it is possible to judge that a change in traffic conditions occurred during the periods 507 and 508, if the inter-distribution distances of the traffic information data groups in the first and second years in each of the combinations of the periods 501 and 505, the periods 502 and 506 and the periods 503 and 507 are generally the same and the inter-distribution distance of the traffic information data groups in the periods 504 and 508 is different from the first-mentioned inter-distribution distance.

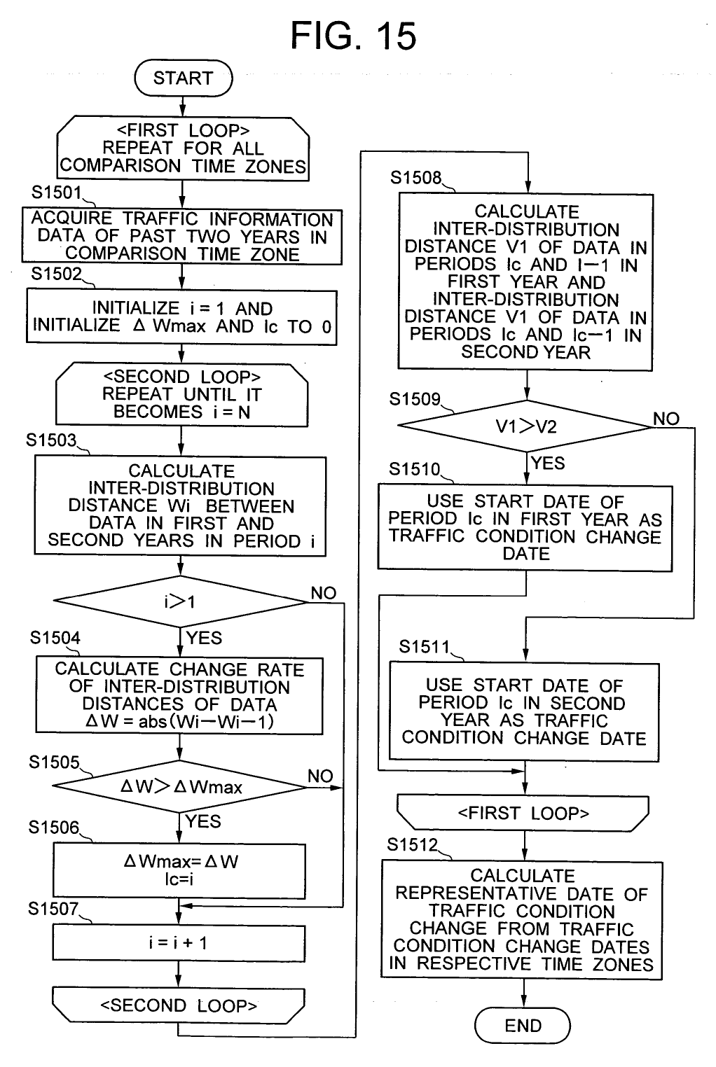

In this case, the flow chart corresponding to that of FIG. 14 is shown in FIG. 15. In the process of a first loop for comparison in each time zone, first at S1501, traffic information data of a road link, from which a change in traffic conditions during the past two years in the comparison time zone is to be detected, is acquired from the traffic information DB 301. Next, at S1502 an index i representative of a period is initialized to 1, and ΔWmax and Ic are initialized to 0. The process of a second loop is repeated until it becomes i=N where N is the number of divided periods per one year shown in FIG. 5. Inside the second loop, the process at S1503 calculates an inter-distribution distance Wi of the traffic information data in the first and second years in the period i. If i>1, the process at S1504 calculates an absolute value ΔW of a change rate of the inter-distribution distances Wi and Wi−1 in the periods i and i−1. ΔW is compared with ΔWmax at S1505. If ΔW is larger than ΔWmax, at S1506 the value of ΔWmax is renewed to ΔW and the value of Ic is renewed to i. If i≦1 or ΔW≦A ΔWmax, the flow advances to S1507. At S1507, 1 is added to i to return to the top of the second loop. After the completion of the second loop, the process at S1508 calculates the inter-distribution distances V1 and V2 of the traffic information data in the first and second years during the periods Ic and Ic−1. If it is judged at S1509 as V1>V2, then at S1510 the start date of the period Ic in the first year is used as the traffic condition change date in the corresponding time zone. If V1<V2, then at S1511 the start date of the period Ic in the second year is used as the traffic condition change date in the corresponding time zone. The process of the first loop from S1501 to S1511 is repeated for all comparison time zones. Thereafter, similar to S1408 shown in FIG. 14, in the process of S1512 determining a representative date in which the traffic conditions changed, a statistical representative value (average value, median value mode value or the like may be used) is calculated from traffic condition change dates in time zones. This statistical representative value is used as a representative date in which the traffic conditions changed. It is noted that the inter distribution distance is the distance between average values, median values or most frequent values of traffic information data (distributions) in the first and second years.

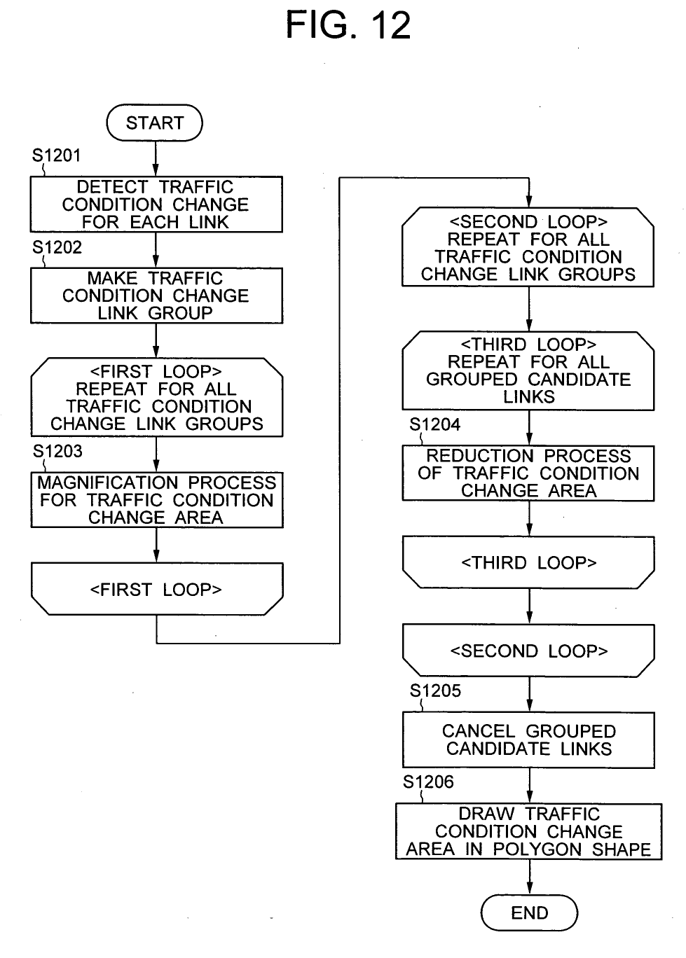

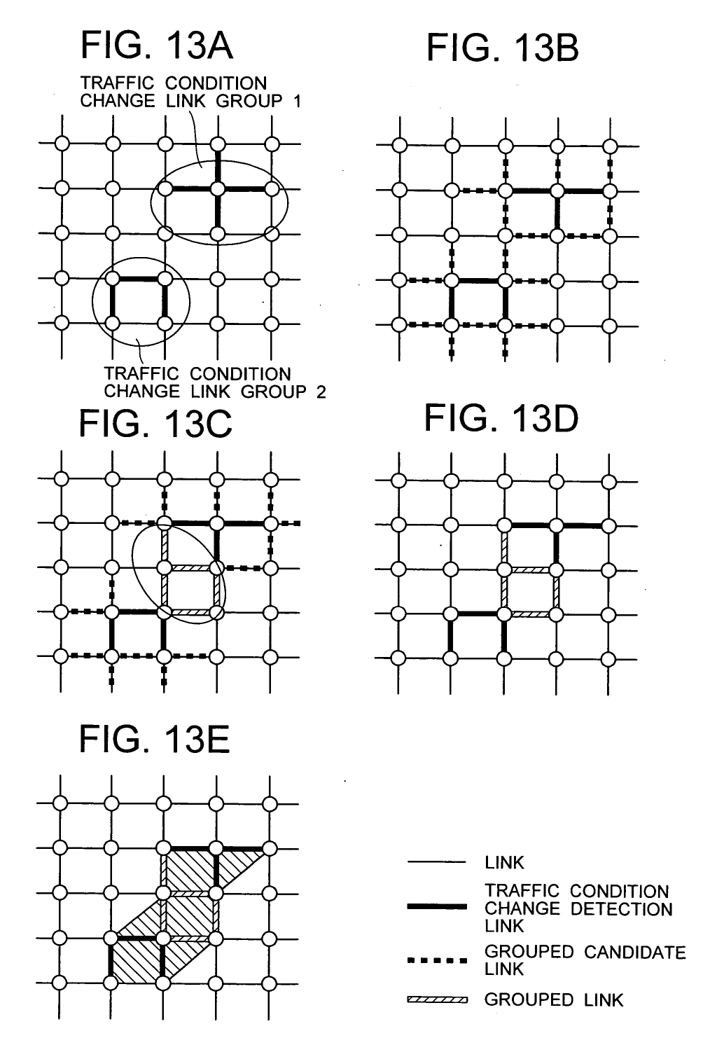

The long term traffic condition detecting apparatus 302 shown in FIG. 3 outputs a detection location and time period of a long term change in traffic conditions detected in the manner described above to a traffic information display apparatus 303. The traffic information display apparatus 303 displays the detection area of a change in traffic conditions as the influence area caused by the long term traffic event, such as the area 107 shown in FIG. 1. If the color or thickness of only a road link from which a change in traffic conditions was detected is changed in displaying the area 107, the traffic event influence area is displayed in some cases as a collection of scattered small areas, because there are road links whose traffic information is not measured. Since such a display is difficult for a user to visually recognize, it is necessary to make detection areas of a change in traffic conditions as one group and display as an area collectively formed to some extent. This display method is illustrated in the flow chart of FIG. 12. At S1201, a change in traffic conditions is detected at each road link by the method illustrated in FIGS. 4 and 5. At S1202 a link from which a change in traffic conditions was detected is used as a traffic condition change link, continuous traffic condition change links are collected as one traffic condition change link group such as shown in FIG. 13A. An area coupling terminals of the link group is used as the traffic condition change area. Next, in a first loop, at S1203 a magnification process for the traffic condition change area is executed for each traffic condition change link group. In the magnification process for the traffic condition change area, as shown in FIG. 13B road links which are adjacent to the traffic condition change link group and from which a change in traffic conditions was not detected, are registered as grouped candidate links for the traffic condition change link group. Next, in a second loop, a process of a third loop is repeated for each of all traffic condition change link groups. In the third loop, the process at S1204 is repeated to execute an area reduction process for each grouped candidate link of the traffic condition change link group to be processed. At S1204, as shown in FIG. 13C, grouped candidate links adjacent to another traffic condition change link group or its grouped candidate links are decided as grouped links. After the process of the second loop is completed and grouped links of all traffic condition change link groups are decided, then at S1205 registration of the grouped candidate links is cancelled, leaving the links decided as the grouped links. With these processes, as shown in FIG. 13D the traffic condition change area constituted of a plurality of adjacent small link groups can be changed to a grouped traffic condition change area constituted of a large link group including the plurality of adjacent small link groups. The traffic condition change area grouped by the above processes is a collection of line segments representative of road links. This traffic condition change area is displayed on the screen in a polygon shape such as the area 107 shown in FIG. 1 at S1206 by coupling terminal points at the border between the traffic condition change detection links and grouped links and the other links and making solid the inside of the polygonal area, as shown in FIG. 13E.

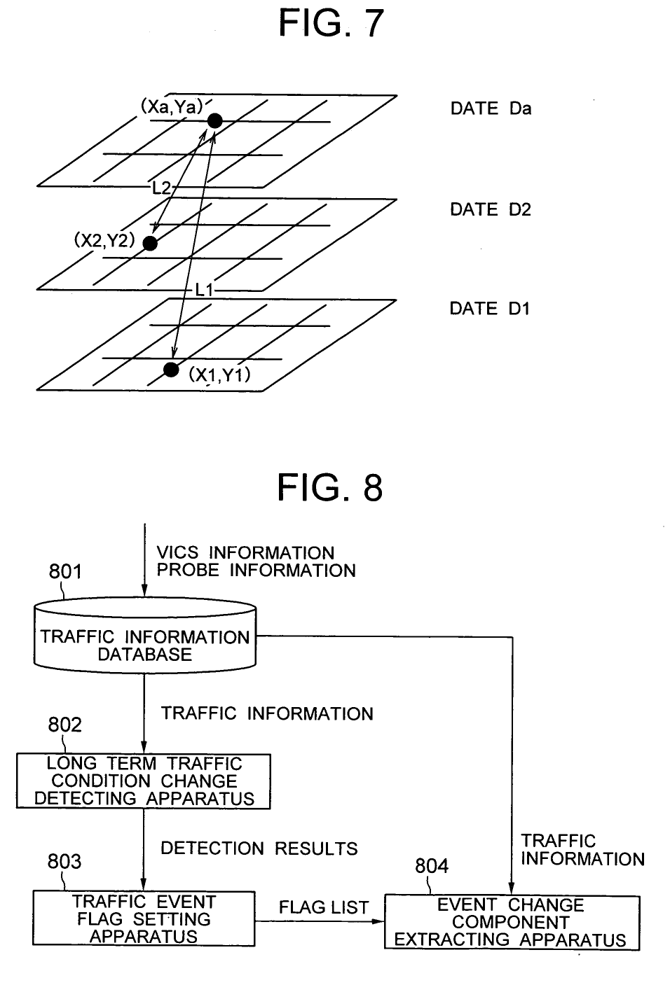

The following method is used for displaying the type and display position of the traffic event icon 104 and the character information in the character information display unit 109 in correspondence with the detection results of a change in traffic conditions by the long term traffic condition change detection apparatus 302. Namely, a traffic event retrieval apparatus 305 selects a traffic event from a traffic event DB 304, the traffic event having a highest similarity to the position and time period of a change in traffic conditions detected by the long term traffic condition change detection apparatus 302. In accordance with the selected traffic event, the traffic event retrieval apparatus 305 outputs the corresponding icon or character information to the traffic information display apparatus 303. Information stored in the traffic event DB 304 is, for example, information on a traffic event type, an event occurrence location, an event occurrence time period, event contents and the like, such as shown in FIG. 6. This information is generated in accordance with information sent to, for example, an administrative organization. A temporal and spatial area in which the traffic conditions are influenced is difficult to be identified from a traffic event of the traffic event information itself shown in FIG. 6, and moreover there are traffic events not influencing the traffic conditions. It is therefore not easy to confirm a correspondence between a traffic event and actual traffic conditions. However, by using the detection results by the long term traffic condition change detection apparatus 302, it is possible to confirm a correspondence between the information shown in FIG. 6 and an actual change in traffic conditions. A criterion for correspondence confirmation is a geographical distance between the occurrence location and time period of a traffic event stored in the traffic event DB 304 and the location and time period of a change in traffic conditions detected by the long term traffic condition change detection apparatus 302. FIG. 7 is a conceptual diagram illustrating a process to be executed by the traffic event retrieval apparatus 305. It is assumed that a traffic event #1 occurred on a date D1 at coordinates (X1, Y1) and a traffic event #2 occurred on a date D2 at coordinates (X2, Y2). It is also assumed that the long term traffic condition change detection apparatus 302 detects a change in traffic conditions at a date Da at coordinates (Xa, Ya). A distance Li between a change in traffic conditions and a traffic event i is calculated by the following equation (1):
Li=Wt×(Di−Da)²+W1×(Xi−Xa)²+W1×(Yi−Ya)²(i=1, 2, 3, . . . ) (1)

In the equation (1), Wt and Wi are weight coefficients of a temporal distance and a spatial distance, respectively. The traffic event retrieval apparatus 305 selects the traffic event having the shortest distance Li as a cause event of a change in traffic conditions detected by the long term traffic condition change detection apparatus 302. In this example, assuming that L1>L2, the traffic event #2 is judged as the cause event and the contents of the traffic event #2 are output to the traffic information display apparatus 303. This process is also applicable to the case in which there are a plurality of traffic events registered in the traffic event DB 304. Although a simple straight line distance is used to represent a spatial distance, a cause event can be selected more precisely by using a route search approach. Evaluation of the temporal distance is not necessarily linear, and calculation of the distance between a traffic event and a change in traffic conditions is not limited to the equation (1). General calculation of the distance Li can be expressed by the following equation (2):
Li=Wd×Ld(Di, Da)+Wp×Lp (Pi, Pa) (2)

In the equation (2), Ld (Di, Da) is a function of a temporal distance between the traffic event i and a change in traffic conditions, and Lp (Pi, Pa) is a function of a spatial distance between the traffic event i and a change in traffic conditions. These functions can be obtained from the positions Pi and Pa by using the route search approach or the like. Wd is a weight coefficient of the temporal distance and Wp is a weight coefficient of the spatial distance.

In this embodiment, the traffic information providing system includes the traffic information DB 301, traffic event DB 304 and traffic information display apparatus 303. The system may be constituted of: a traffic information server having the traffic information DB 301, the traffic condition change detection apparatus for detecting a change in traffic conditions, the traffic event DB 304 to be used for retrieving a traffic event and the traffic event retrieval apparatus 305; and a communication terminal having the traffic information display apparatus 303, the communication terminal such as a car navigation apparatus for providing traffic information receiving the detection results and retrieved traffic event information sent from the traffic information server. The traffic information server acquires traffic condition change information and traffic condition change cause information corresponding to the spatial range and temporal range designated by the communication terminal, and transmits the acquired traffic information to the communication terminal. Alternatively, the traffic condition change detection apparatus monitors a change in traffic conditions periodically or when the communication terminal communicates with the traffic information server, and when a change in traffic conditions is detected, the traffic information is supplied to the communication terminal by transmitting the traffic condition change information and traffic condition change cause information.

### SECOND EMBODIMENT

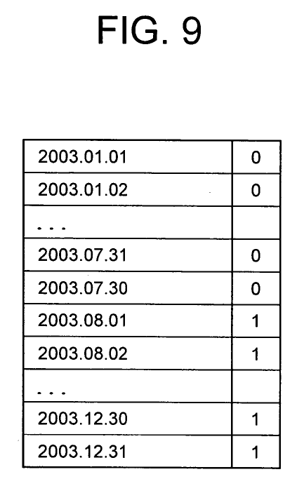

FIG. 8 is a block diagram of the second embodiment having an event change component extracting apparatus which extracts components changed by a traffic event from past traffic information, in accordance with the detection results of a change in traffic conditions detected by a long term traffic condition change detection apparatus in the manner described with reference to FIGS. 4 and 5. Similar to the long term traffic condition change detection apparatus 302 shown in FIG. 3, a long term traffic condition change detection apparatus 802 detects a change in traffic conditions by executing the processes shown in FIG. 14 and using the traffic information distributed from VICS or a probe car/floating car system and stored in a traffic information DB 801, and outputs the detection results to a traffic event flag setting apparatus 803. When the long term traffic condition change detection apparatus 802 detects a change in traffic conditions, the traffic event flag setting apparatus 803 generates a list of traffic event flags such as illustratively shown in FIG. 9, in accordance with the representative date of the change in traffic conditions output by the process at S1407 shown in FIG. 14. As shown in FIG. 9, the traffic event flag list has one flag per one day. The flag value of “0” indicates that the date is before the representative date of a change in traffic conditions, whereas the flag value “1” indicates that the date is after the representative date of a change in traffic conditions. An event change component extracting apparatus 804 determines a constant term a0 and a coefficient a1 in such a manner that an error between an actually measured value of traffic information data Y and a value calculated by the following regression equation (3) becomes minimum, the regression equation having the constant term a0 and coefficient a1 and a traffic event flag f set by the traffic event flag setting apparatus 803:
Y=a0+a1×f (3)

In the equation (3), the constant term a0 corresponds to the components not changed by the traffic event, and the coefficient a1 corresponds to the components changed by the traffic event. Although the binary values “0” and “1” are used as the traffic event flag, if multi-values are used as the traffic event flag, continuously changing traffic conditions can be processed. If a traffic event occurs not once but a plurality of times during the period while traffic information is stored in the traffic information DB 801, M traffic event flags f1 to fM are used and the following regression equation (4) is used so that components changed by the i-th traffic event can be expressed by the i-th coefficient ai:
Y=a0+a1×f1+a2×f2+, . . . , +aM×fM (4)

### THIRD EMBODIMENT

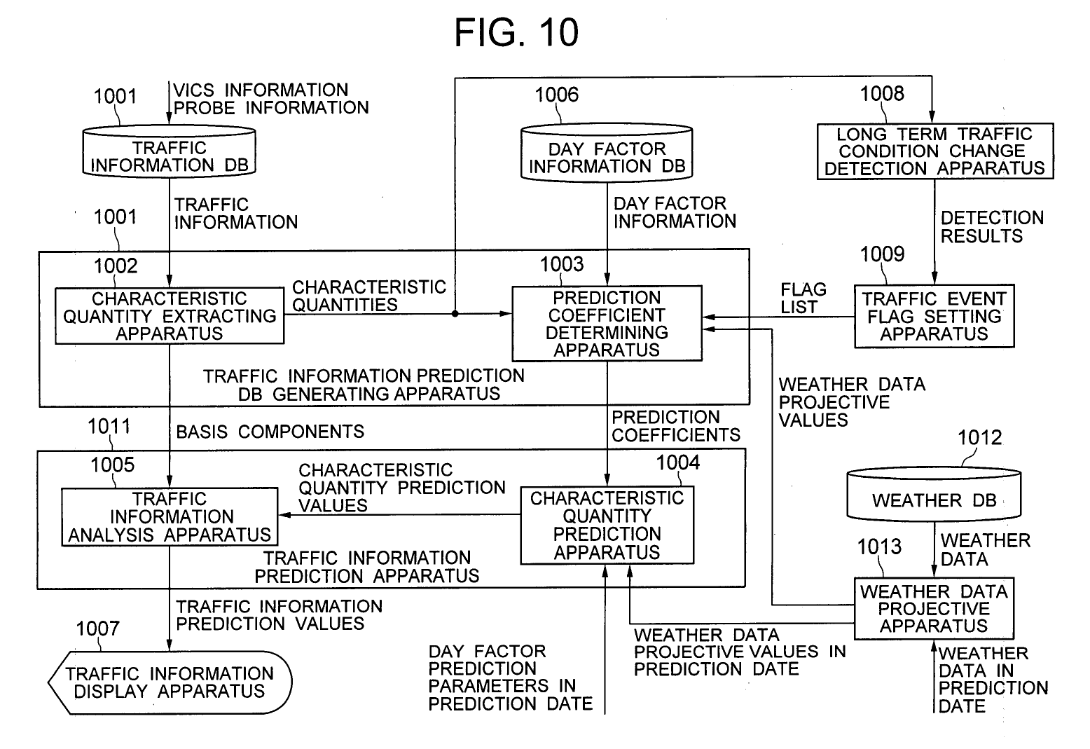

As shown in the block diagram of FIG. 8, a temporal resolution of traffic information capable of being processed depends on a temporal resolution of a traffic event flag which is an independent variable. Therefore, as a list of one-day unit traffic event flags illustratively shown in FIG. 9 is formed, the temporal resolution is one-day unit. FIG. 10 is a block diagram of a traffic information prediction system capable of processing traffic information having an arbitrary temporal resolution, according to the third embodiment of the invention. A characteristic quantity extracting apparatus 1002 calculates basis components and characteristic quantities (component scores) from past traffic information data distributed from VICS or a probe car/floating car system and stored in a traffic information DB 1001 like the traffic information DB 801, by a main component analysis approach or the like. The basis components are a plurality of elements constituting original traffic information, each of the basis components has the same temporal resolution as that of the original traffic information, and the basis components are a sequence having a length corresponding to traffic data of one day. A plurality of basis components can be approximately synthesized as traffic information of one day through a linear sum of original traffic information. The characteristic quantities having the same number as that of the basis components can be obtained, and are used as a coefficient of each basis component when the traffic information is synthesized from the basis components. Each of the characteristic quantities is time sequential data having a temporal resolution of one-day unit. The characteristic quantity extracting apparatus 1002 outputs the characteristic quantities to a prediction coefficient determining apparatus 1003 and a long term traffic condition change detection apparatus 1008, and the basis components to a traffic information synthesis apparatus 1005.

The long term traffic condition change detection apparatus 1008 is similar to the long term traffic condition change detection apparatus 302 shown in FIG. 3. The long term traffic condition change detection apparatus 1008 detects a change in traffic conditions and its timing from time sequential data of each characteristic quantity, by using a process of detecting a change in traffic conditions described with reference to FIG. 4 or 5, and outputs the detection results to a traffic event flag setting apparatus 1009. When the long term traffic condition detection apparatus 1008 detects a change in traffic conditions, the traffic event flag setting apparatus 1009 generates the event flag list in accordance with the detection results, and outputs it to the prediction coefficient determining apparatus 1003.

The prediction coefficient determining apparatus 1003 calculates prediction coefficients by a multiple regression analysis approach or the like, from the characteristic quantities input from the characteristic quantity extracting apparatus 1002, day factor information during the period used for the characteristic quantity extracting apparatus 1002, and the traffic event flag list input from the traffic event flag setting apparatus 1009. These prediction coefficients are used for a characteristic quantity prediction apparatus 1004 to calculate prediction values of the characteristic quantities in a prediction date, by using a prediction model using day factors as parameters. The calculated prediction coefficients are recorded in the characteristic quantity prediction apparatus 1004. The day factor information is classification information on days of the week, commercial calendar, weekdays/holidays, consecutive holidays, school holidays, weather and the like, and is recorded in a day factor information DB 1006. When the prediction coefficients are calculated, day factor information during the period used for the characteristic quantity extracting apparatus 1002 is read from the day factor DB 1006.

If multiple regression analysis is used for prediction calculation of characteristic quantities, the function type of the prediction model is a linear sum of day factors. The characteristic quantity T to be predicted is expressed by the following equation (5) by using binary independent variables d1, d2, . . . , dN representing by “1” and “0” whether the day factor corresponds to which one of N day factors, prediction coefficients a1, a2, . . . , aN and the traffic event flag f and a flag coefficient c:
T=a1×d1+a2×d2+, . . . , +aN×dN+c×f (5)

If numerical data such as a temperature and a precipitation is to be reflected upon the prediction model, terms of multi-value independent variables x1, x2, . . . , xM are added to the equation (5) to use the prediction model expressed by the following equation (6):
T=a1×d1+a2×d2+, . . . , +aN×dN+c×f+b1×x1+b2×x2+, . . . , +bM×xM (6)

Although terms of first-order multi-value independent variables are used in the equation (6), prediction models having second-, third-order, . . . , terms may also be used. A more general function type of the prediction model is represented by the following equation (7), and the prediction coefficient determining apparatus 1003 identifies coefficients of such a function F from the characteristic quantity, day factor information and traffic event flags:
T=F(d1, d2, . . . , dN, f, x1, x2, . . . , xM) (7)

When weather data such as a precipitation is processed as multi-value independent variables and if the data has a temporal resolution in the one-day unit, the prediction model by the equation (6) or (7) can be used. If the weather data has a temporal resolution finer than the one-day unit, in order to process the weather data in a manner similar to the binary independent variables and traffic event flags, it is necessary to convert the weather data into weather data having a temporal resolution of the one-day unit. A simple method is to divide original data into data in each time zone and collect these data to assign one time zone with one multi-value independent variable. For example, if one day is divided into four time zones, four independent variables x1, x2, x3 and x4 representative of the weather data in the four time zones are used for the equation (6) or (7). This method using time zone division is, however, associated with problems such as multicollinearity of multiple regression, if there is a correlation between data in one time zone and data in another time zone. This problem can be solved by projecting weather data of each day on a data space constituted of spatial axes without correlation and using values on a projective axis (projective coordinate values) as the multi-value independent variables of the equation (6) or (7). In the example shown in FIG. 10, if weather data such as a precipitation is processed, a weather DB 1012 and a weather data projective apparatus 1013 are added to the system. The weather data projective apparatus 1013 projects the weather data supplied from the weather DB 1012 upon a data space constituted of axes without correlation, and the projective coordinate values in such a projective data space are input to the projection coefficient determining apparatus 1003. The axes of the data space used by the weather data projective apparatus 1013 for projection may be set arbitrarily if the axes have no correlation. Alternatively, axes having a large data dispersion are obtained through analysis of main components of past weather data and used as the axes of the data space.

If the long term traffic condition change detection apparatus 1008 cannot detect a change in traffic conditions, the traffic event flag term is removed from the prediction models.

For prediction on traffic information, prediction parameters of day factors necessary for the prediction model are input to the characteristic quantity prediction apparatus 1004 in accordance with an event in the prediction date. The traffic event flag term of the prediction model is set to “1” if traffic information is to be predicted by considering the influence of the traffic event. If weather data is used for prediction, projective prediction coordinate values obtained by inputting a weather data prediction value in the prediction date to the weather data projective apparatus 1013 are input to the characteristic quantity prediction apparatus 1004 as weather parameters. The characteristic quantity prediction apparatus 1004 calculates characteristic quantity prediction values in accordance with the input prediction parameters and projective coordinate values and the recorded prediction coefficients input from the prediction coefficient determining apparatus 1003, and inputs the calculated characteristic quantity prediction values to the traffic information synthesis apparatus 1005.

The traffic information synthesis apparatus 1005 synthesizes the recorded basis components input from the characteristic quantity extracting apparatus 1002 by using as the coefficients the characteristic quantity prediction values. This synthesized value is a prediction value of the traffic information corresponding to the prediction parameters input to the characteristic quantity prediction apparatus 1004, and is output to a traffic information display apparatus 1007. In the example shown in FIG. 10, although the prediction value of the traffic information is output to the traffic information display apparatus 1007, the predicted traffic information may be input to a route search unit of a car navigation apparatus or a car disposition planning unit of a car disposition management system.

A portion of the system shown in FIG. 10 may be constituted as sub-systems of a traffic information prediction DB generating apparatus 1010 and a traffic information prediction apparatus 1011. In this case, the processes of the traffic information prediction DB generating apparatus 1010 and the long term traffic condition change detection apparatus 1008 are executed off-line and only the processes of the traffic information prediction apparatus 1011 are executed on-line to provide traffic information.

### FOURTH EMBODIMENT

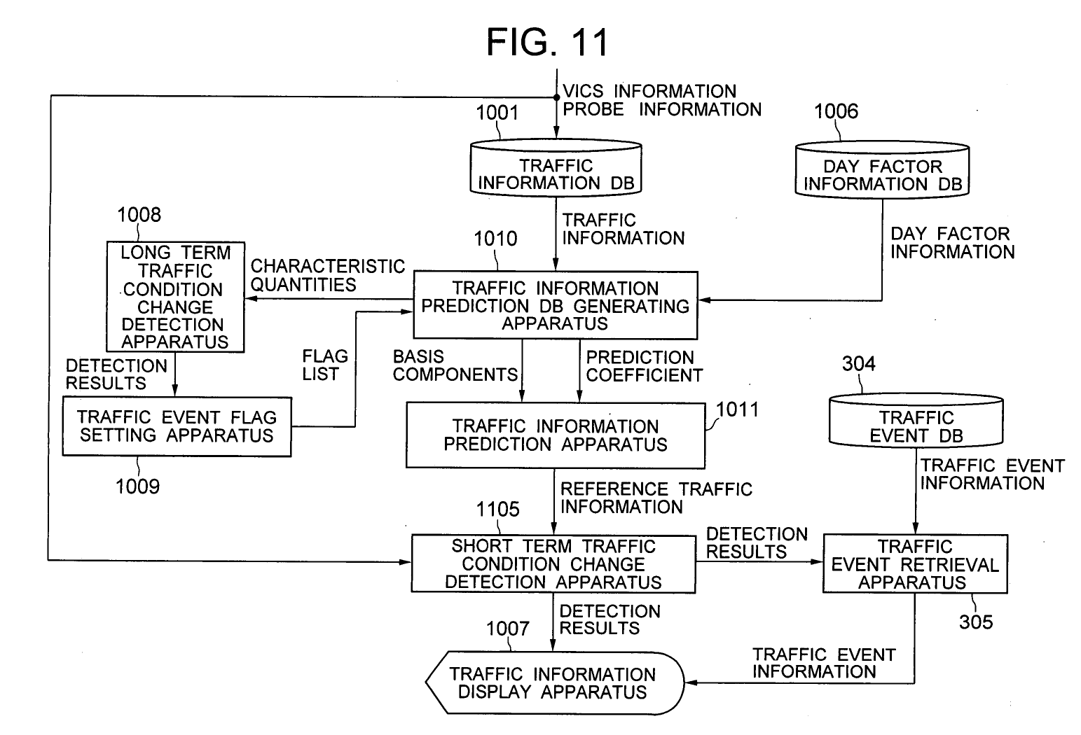

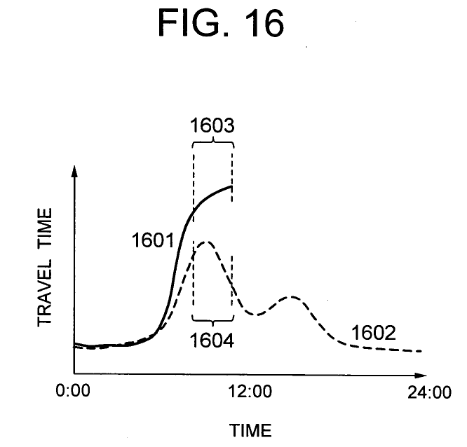

FIG. 11 shows the structure of a traffic information prediction system for detecting an occurrence of a short term traffic event such as an accident and short term construction or events such as road races, according to another embodiment of the present invention. Similar to the system of FIG. 10, a traffic information prediction DB generating apparatus 1010 calculates basis components and prediction coefficients necessary for prediction processes by a traffic information prediction apparatus 1011, by using traffic information accumulated in a traffic information DB 1001 and day factors stored in a day factor DB 1006. The traffic information prediction apparatus 1011 calculates traffic information prediction values from prediction parameters in a present day, and inputs them as reference traffic information to a short term traffic condition change detection apparatus 1105. The short term traffic condition change detection apparatus 1105 evaluates data distributions of a data group 1603 and a data group 1604, for example, in past two hours of traffic information 1601 in the present day and the reference traffic information 1602 shown in FIG. 16, through comparison using dispersion or χ-square test. If it is judged that the data groups have statistically different distributions, it is judged that the traffic conditions changed by some short term traffic event, and the short term traffic condition change detection apparatus 1105 outputs the time and location of the traffic event on the road to a traffic information display apparatus 1007. The traffic information display apparatus 1007 displays the influence area of a change in traffic conditions caused by the short term traffic event, such as the area 108 shown in FIG. 1. In accordance with the detection results of the short term traffic condition change detection apparatus 1105, a cause event is identified by using a traffic event DB 304 and a traffic event retrieval apparatus 305, similar to the system shown in FIG. 3, and a corresponding icon or character information is displayed on the traffic information display apparatus 1007, such as shown in FIG. 1. If the traffic information prediction apparatus 1011 calculates the reference traffic information by considering also a long term traffic event such as road building and opening of a large scale shop, a long term traffic condition change detection apparatus 1008 and a traffic event flag setting apparatus 1009 are added to the traffic information prediction system, similar to the system shown in FIG. 10, and the traffic information prediction DB generating apparatus 1010 calculates prediction coefficients by considering a change in traffic conditions caused by a long term traffic event.

The system shown in FIG. 11 detects a short term traffic event by using day factor information, without simply comparing distributions of all data of past traffic information with real time traffic information. The reason for this is given in the following. For example, it is assumed that a road has a congestion peak in morning and night of weekdays and a congestion peak only in night of holidays. In this case, even if congestion occurs because of an accident in morning in a holiday, comparison between the real time traffic information and distributions of all data of the past traffic information results in that data of congestion by the holiday accident is buried in the congestion peak in morning in a weekday so that the occurrence of the accident cannot be detected. In the system shown in FIG. 11, statistical reference information is generated in accordance with day factor information of a present day, and the statistical reference information is compared with the real time information so that only a fluctuation by a short term traffic event unable to be explained from the day factor information can be detected as abnormal data.

The present invention is applicable to improving added values of traffic information provided by traffic information services. A traffic information provider utilizing the present invention can provide a communication type car navigation apparatus, a portable phone, a PDA, a PC, a digital TV and the like with information on a change in traffic conditions caused by a traffic event.

It should be further understood by those skilled in the art that although the foregoing description has been made on embodiments of the invention, the invention is not limited thereto and various changes and modifications may be made without departing from the spirit of the invention and the scope of the appended claims.

1. A traffic information providing apparatus comprising:
a traffic information database for recording time sequential data of traffic information;
a traffic condition change detection unit which detects a location and time period of a traffic event causing a change in data distribution of the traffic information and outputting the location and time period as traffic condition change information;
a traffic event database for recording a location, time period and type of the traffic event capable of changing traffic conditions;
a traffic event retrieval unit which retrieves a traffic event corresponding to the location or time period of the traffic condition change information from said traffic event database, and outputting the location and type of the retrieved traffic event as traffic condition change factor information; and
a display unit which displays said traffic condition change information and said traffic condition change factor information.

2. The traffic information providing apparatus according to claim 1, wherein said display unit displays on a map the location of said traffic condition change information and the location and type of said traffic condition change factor information.

3. The traffic information providing apparatus according to claim 1, wherein said display unit displays said traffic condition change factor information output from said traffic event retrieval unit and information on a factor of a change in traffic conditions among traffic information provided by traffic information services of an administrative organization or a private organization, on a map in a superposed manner by using icons corresponding to types of these information.

4. A traffic information providing method comprising steps of:
detecting a location and time period of a traffic event changing data distribution of traffic information from time sequential data of past traffic information;
retrieving a traffic event corresponding to the location and time period of the traffic event changing data distribution from a traffic event database for recording a location, time period and type of each traffic event capable of changing traffic conditions; and
providing the position of the change in said data distribution and the position and type of said retrieved traffic event.

5. A traffic information providing method comprising steps of:
detecting a time period during which data distribution of traffic information is changed, from time sequential data of past traffic information; and
calculating a change quantity of traffic information by linear or nonlinear regression analysis using traffic condition variables representing the data distributions before and after the change by different numerical values,
wherein in detecting the time period during which the data distribution of the traffic information is changed, a change in the data distribution of the traffic information removing an influence of a season variation is detected by comparing the data distributions of the traffic information of a plurality of years divided into data groups of a same season, a same month, a same week and the like.

6. A traffic information providing method comprising steps of:
detecting a time period during which data distribution of traffic information is changed, from time sequential data of past traffic information; and
calculating coefficients of a linear or nonlinear regression model for approximately estimating traffic information, by using, as parameters, traffic condition variables representing said data distribution before and after the change by different numerical values, and day factor variables representing a correspondence with day factors including days of the week, weekdays/holidays, seasons, commercial calendar and the like,
wherein in providing a prediction value of the traffic information in a future day, the traffic information is provided by using said regression model setting said traffic condition variables to numerical values representative of said data distribution after the change, and setting said day factor variables to numerical values representative of the day factor of the future day.

7. The traffic information providing method according to claim 6, wherein:
the traffic information is time sequential data having a higher temporal resolution than one-day interval;
an object to be approximately estimated by said regression model is traffic information characteristic quantities obtained by projecting the traffic information of each day upon a traffic information feature space constituted of axes without correlation; and
in providing the prediction value of the traffic information in the future day, the traffic information is provided which is obtained by reversely projecting said traffic information characteristic quantities from said traffic information feature space, said traffic information characteristic quantities being obtained by using said regression model setting said traffic condition variables to numerical values representative of said data distribution after the change, and setting said day factor variables to numerical values representative of the day factor of the future day.

8. The traffic information providing method according to claim 6, wherein:
said regression model uses, as parameters, said traffic condition variables, said day factor variables and weather information characteristic quantities obtained by projecting the traffic information of each day upon a weather information feature space constituted of axes without correlation; and
in providing the prediction value of the traffic information in the future day, the traffic information is provided which is obtained by using said regression model setting said traffic condition variables to numerical values representative of said data distribution after the change, setting said day factor variables to numerical values representative of the day factor of the future day, and setting said weather information characteristic quantities to numerical values obtained by projecting weather information of the future day upon said weather information feature space.
